(19) United States
(12) Patent Application Publication
(10) Pub. No.: US 2013/0086171 A1
(43) Pub. Date: Apr. 4, 2013

(54) SYSTEM AND METHOD FOR PROVIDING TRENDING INFORMATION RELATED TO INDIVIDUAL PASSIONS

(71) Applicants: Tushar Sayankar, Gurnee, IL (US); Rutvik Sayankar, Gurnee, IL (US)

(72) Inventors: Tushar Sayankar, Gurnee, IL (US); Rutvik Sayankar, Gurnee, IL (US)

(21) Appl. No.: 13/633,925

(22) Filed: Oct. 3, 2012

Related U.S. Application Data
(60) Provisional application No. 61/542,800, filed on Oct. 4, 2011.

(51) Int. Cl. G06F 15/16

(52) U.S. Cl. 709/204

(57) ABSTRACT

The present invention generally relates to providing trending information related to individual passions. Specifically, this invention relates to a system and method for providing a way for one or more users to view and analyze likes and dislikes of individuals over a variable span of time and make predictions or recommendations based on said likes and dislikes.

### CROSS REFERENCE TO RELATED APPLICATIONS

This application claims the benefit of U.S. Provisional Patent Application No. 61/542,800 filed Oct. 4, 2011, the entire disclosure of which is incorporated herein by reference.

### FIELD OF THE INVENTION

The present invention generally relates to providing trending information related to individual passions. Specifically, this invention relates to a system and method for providing a way for one or more users to view and analyze likes and dislikes of individuals over a variable span of time and make predictions or recommendations based on said likes and dislikes.

### BACKGROUND OF THE INVENTION

To many people, a quality education is highly valued asset and one of the best investments a person can make in themselves. As a result, people are constantly developing new educational methods that can make the educational process more productive and efficient. One of the most difficult aspects in education is tailoring a program to an individual so that the strengths of the individual can be appropriately developed, while the weaknesses are constantly improved. Additionally, it is challenging to create an educational program that is customized to account for the passions of an individual, as well as harness and nurture those passions to direct that individual towards a career or other calling that draws on those passions.

Therefore, there is a need in the art for a system and method for identifying trends in an individual's educational preferences so that a tailored program can be designed to meet that individual's educational goals while taking into account that individual's passions. These and other features and advantages of the present invention will be explained and will become obvious to one skilled in the art through the summary of the invention that follows.

### SUMMARY OF THE INVENTION

Accordingly, it is an aspect of the present invention to provide a system and method for providing trending information related to individual passions and feedback to nurture and develop those passions.

According to an embodiment of the present invention, a system for providing trending information using a social networking platform, the system includes of a trend tracking module comprising a processor and a physical memory storing instructions that causes the trend tracking module to, provide a user interface, register a user, wherein the user becomes a part of a social network that evaluates activities of the user, provide one or more activities to the user, analyze interactions of the user with said one or more activities, wherein the interactions are tracked over time to identify trends, and provide feedback to the user via the user interface, wherein the feedback is based on identified trends.

According to an embodiment of the present invention, a system for providing trending information using a social networking platform further includes a communications means, wherein the communications means allows the user to utilize the trend tracking module through a computer network.

According to an embodiment of the present invention, a system for providing trending information using a social networking platform further includes a data store, wherein the data store includes one or more activities for the user to interact with.

According to an embodiment of the present invention, a system for providing trending information using a social networking platform is used for educational purposes.

According to an embodiment of the present invention, a system for providing trending information using a social networking platform is used by school-aged children.

According to an embodiment of the present invention, a system for providing trending information using a social networking platform, wherein the one or more activities are educational activities.

According to an embodiment of the present invention, a system for providing trending information using a social networking platform, wherein the educational activities are interactive questions.

According to an embodiment of the present invention, a system for providing trending information using a social networking platform, wherein in said identified trends are likes and dislikes of said user.

According to an embodiment of the present invention, a system for providing trending information using a social networking platform, wherein the feedback identifies one or more attributes of the user, wherein the one or more attributes comprise the aptitude, passions, strengths, and weaknesses of the user.

According to an embodiment of the present invention, a method for providing trending information using a social networking platform, the method including the steps of: providing a user interface to a user via a trend tracking module, registering the user, wherein the user becomes a part of a social network that evaluates activities of the user, providing one or more activities to the user, analyzing interactions of the user with the one or more activities, wherein the interactions are tracked over time to identify trends, providing feedback to the user via the user interface, wherein the feedback is based on identified trends.

According to an embodiment of the present invention, a method for providing trending information using a social networking platform further comprising the step of identifying one or more attributes of the user, wherein the one or more attributes comprise the aptitude, passions, strengths, and weaknesses of the user.

According to an embodiment of the present invention, a method for providing trending information using a social networking platform further comprising the step of providing recommendations for future activities, wherein the recommendations are based on the one or more attributes of the user.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is a schematic of an exemplary embodiment of a web-based system for providing trending information related to individual passions;

FIG. 4 is a schematic of an exemplary embodiment of a local system for providing trending information related to individual passions; and

FIG. 5 is a flowchart of an exemplary method in accordance with an embodiment of the present invention.

### DETAILED SPECIFICATION

The present invention generally relates to providing trending information related to individual passions. Specifically, this invention relates to a system and method for providing a way for one or more users to view and analyze likes and dislikes of individuals over a variable span of time and makes predictions or recommendations based on said likes and dislikes.

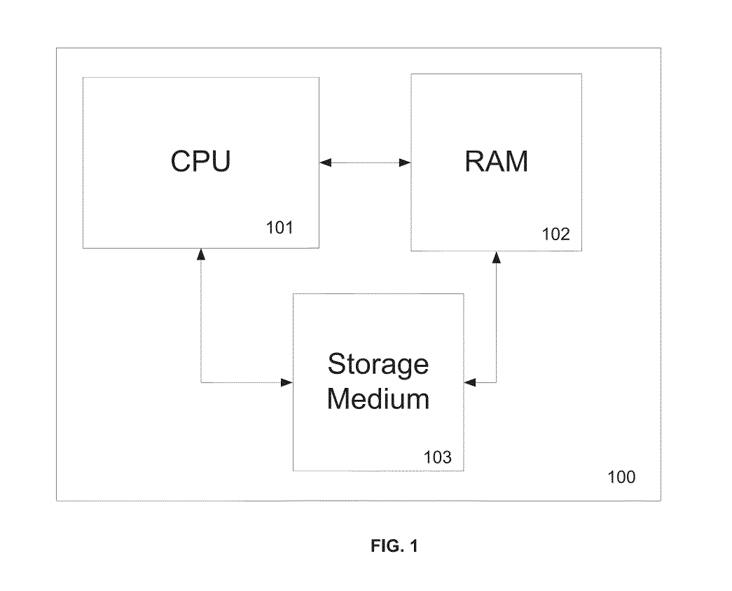

According to an embodiment of the present invention, the system and method is accomplished through the use of one or more computing devices. As shown in FIG. 1, one of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

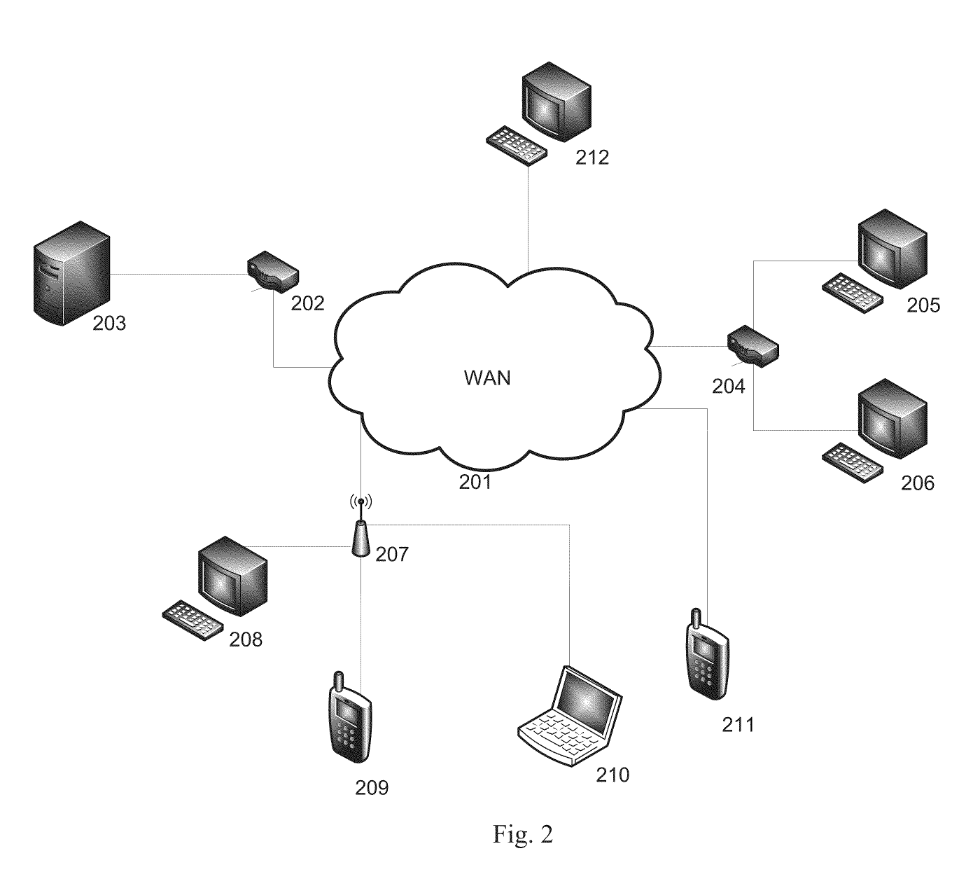

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 101 (e.g., the Internet).

According to an exemplary embodiment, as shown in FIG. 2, exchange of information through the WAN 201 or other network may occur through one or more high speed connections directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information.

Users may connect to server 203 via WAN 201 or other network in numerous ways. For instance, a user may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a member may connect to Server 203 via WAN 201 or other network, and embodiments of the present invention are contemplated for use with any method for connecting to Server 203 via WAN 201 or other network. Furthermore, server 203 could be comprised of a personal computing device, such as a smartphone, acting as a host for other computing devices to connect to.

According to an embodiment of the present invention, an individual or organization may signup to become a user of the system herein provided. In an exemplary embodiment, an individual or organization would go through a registration process, whereby they would provide identifying information to be stored in application server 203. This identifying information may be used, for instance, to identify the user, verify certifications or credentials, secure their login or process financial transactions. One of ordinary skill in the art would appreciate there are numerous ways to provide and manage registration processes, and embodiments of the present invention are contemplated for use with any method for providing and managing registration processes.

According to an embodiment of the present invention, the systems and methods herein described may be implemented through the use of a trend tracking module. The trend tracking module is configured to track trends in a user's likes and dislikes by monitoring the activities of the user. In a preferred embodiment, the trend tracking module provides activities for a user to interact with. As the user completes the activities, the trend tracking module analyzes the interactions and tracks the trends in such interactions. One of ordinary skill in the art would appreciate that trend tracking module could be used to track many activities and interactions, and embodiments of the present invention are contemplated for use with any such activity or interaction.

According to an embodiment of the present invention, the systems and methods herein described are directed to providing a social networking platform, whereby a user may become a registered user and be offered certain social networking functionalities. Through the use of these social networking functionalities, a user's likes and dislikes may be tracked over time to identify trending information related to the user's passions. The following exemplary embodiment is described in the terms of a social networking site directed towards school-age children and is configured to track the passions of a school-age child. While this exemplary embodiment is the focus of this application, one of ordinary skill in the art would appreciate that the systems and methods described herein could be used with any type of social networking format, and embodiments of the present invention are contemplated for use with any social networking format.

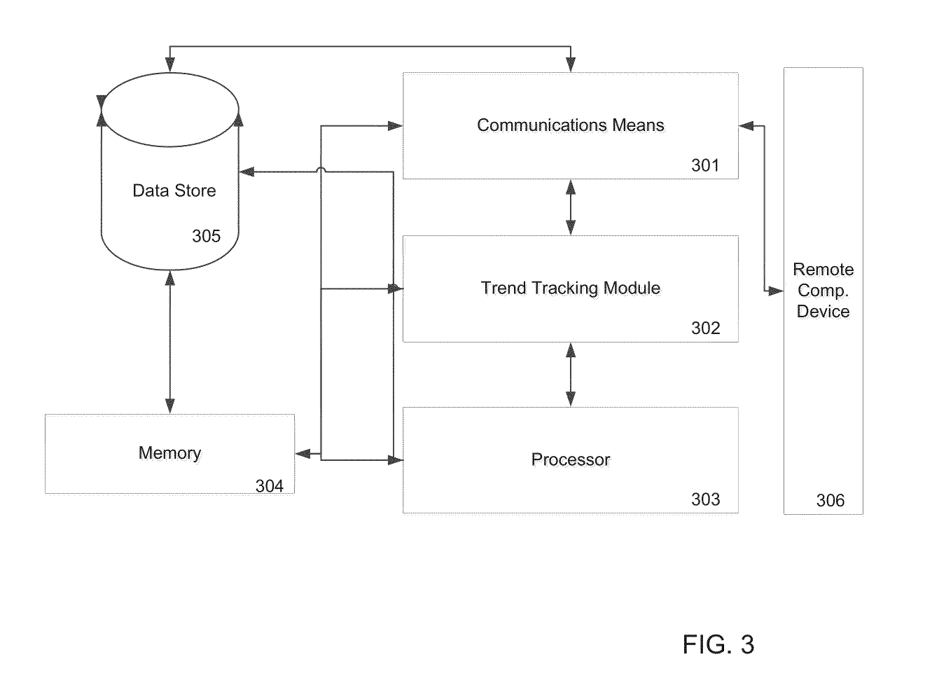

Turning now to FIG. 3, an exemplary embodiment of a system for providing trending information related to individual passions is shown. In this embodiment, the system includes a communications means 301, a trend tracking module 302, a processor 303, a non-transitory memory module 304 and a data store 305. In this embodiment, the trend tracking module 302 works in conjunction with the processor 303, memory 304, data store 305 and communications means 301 to track trends in user's activities and interests for a remote computing device 306. This is a web-based system model, whereby the system provides processing functionality for a remote user by processing requests received from the user based on inputs received from the user. While the embodiment shown in FIG. 3 is an exemplary embodiment, other embodiments may include additional or fewer components. One of ordinary skill in the art would appreciate that there are numerous configurations of the components that could be utilized with embodiments of the present invention, and embodiments of the present invention are contemplated for use with any configuration of components.

According to an embodiment of the present invention, the communications means of the system may be, for instance, any means for communicating data over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

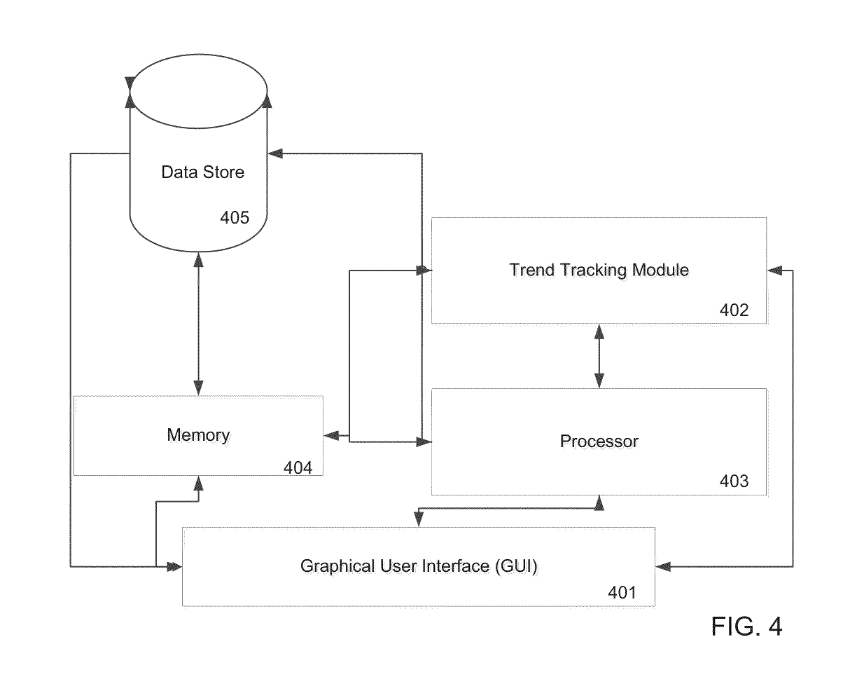

Turning now to FIG. 4, another exemplary embodiment of a system for providing trending information related to individual passions is shown. In this embodiment, the system is provided for on a single computing device, with a graphical user interface (GUI) 401 replacing the communications means 301 of FIG. 3 for communications with a user. Similar to the previously described embodiment, the system is comprised of a trend tracking module 402, a processor 403, a non-transitory memory module 404 and a data store 405. In this embodiment, the trend tracking module 402 works in conjunction with the processor 403, memory 404, data store 405 and GUI 401 to track trends in user's activities and interests for a computing device operated by the user. This is a local system model, whereby the system is generally provided on a single computing device or clustered computing device configured to receive inputs from the user. While the embodiment shown in FIG. 4 is an exemplary embodiment, other embodiments may include additional or fewer components. One of ordinary skill in the art would appreciate that there are numerous configurations of the components that could be utilized with embodiments of the present invention, and embodiments of the present invention are contemplated for use with any configuration of components.

According to an embodiment of the present invention, an educational social networking system and method is provided, whereby a school-age child may register with the system and perform various actions that allow for the child to learn and grow while having his or her educational strengths and passions monitored and reported in reference to a specific time or over a defined time period.

According to an embodiment of the present invention, the trend tracking module may be comprised of computer-executable code stored in non-transitory memory and configured to instruct a processing means (e.g., CPU) to process the computer-executable code in order to perform the desired functionality described herein. The trend tracking module is configured to receive one or more files from one or more sources. The files contain various activities and other programs that a user may interact with. The sources providing the files to the trend tracking module may include, but are not limited to, submission from a user, provided from a data store (e.g., database, storage medium, cloud storage, image provider) or any combination thereof. One of ordinary skill in the art would appreciate that there are numerous manners in which the trend tracking module may receive the files containing the activities and programs the user will interact with.

According to an embodiment of the present invention, interaction with the system may be through various methods provided by the system. In one preferred embodiment, a child may be provided the ability to answer questions in various subjects, aided by automated direction and teaching methods. In an additional preferred embodiment, a child may be provided the ability to create his own questions for other children to answer. According to an embodiment of the present invention, the questions entered by a child may be first checked by one or more users or administrators to verify the veracity of a particular question and answer combination provided by the child. Questions may also be checked for appropriateness for a given age group based on content type.

According to an embodiment of the present invention, the trend tracking module may be configured to assign a difficulty rating to the questions based on one or more variables. In a preferred embodiment, the variables may include, but are not limited to, age, educational grade and number of correct responses from a particular category of individual (e.g., 5 out of 10 5th graders got the question right). One of ordinary skill in the art would appreciate that there are numerous variables that could be used to assign a difficulty rating to the questions, and embodiments of the present invention are contemplated for use with any such variable.

According to an embodiment of the present invention, questions may also be designated with one or more specific subjects (e.g., math, geometry, social science, history, economics, English, Spanish, Latin, biology). In this manner, when a child answers a question or creates a question, the related subject may be identified and used to help identify and track the child's trending passions. Instantaneously, immediate passions can be tracked and identified by what subjects a child is interacting with at the present moment. Additionally, historical passions may be tracked by viewing a child's interests over a designated time period.

According to an embodiment of the present invention, questions may be created in any format. In a preferred embodiment, formats may include, but are not limited to, text, still image, audio, video or any combination thereof. One of ordinary skill in the art would appreciate that there are numerous formats for questions to take, and embodiments of the present invention are contemplated for questions of any format.

According to an embodiment of the present invention, after a question has been answered, a sequence may be presented to the answering individual based upon their response. For instance, a specific sequence may be presented when a question is answered correctly, while a separate sequence may be presented when a question is answered incorrectly. In one embodiment, a sequence describing what was incorrect about a specific chosen answer and identifying what the correct response was could be presented to a user. One of ordinary skill in the art would appreciate that there are numerous types of sequences that could be triggered by responding to a question, and embodiments of the present invention are contemplated for use with any type of response sequence.

According to an embodiment of the present invention, other objective and subjective information may be used to identify a child's current and historical passions. For instance, if a child was answering numerous questions in a specific subject, but the percentage of correct answers given was low, this could be used to identify not only a passion trend, but a characteristic of the child as well. It is quite possible that a child may be passionate about a subject area, but not be particularly motivated by a subject. This could be for any number of reasons, including pressure from outside influences (e.g., parents, teachers) to be better in a subject that a child has little interest or aptitude in.

According to an embodiment of the present invention, a user may be able to register a particular goal or aspiration so that the trend tracking module can recommend activities to help that user meet that goal. In a preferred embodiment, the trend tracking module would prescribe activities for the user that help develop and strengthen skill required to achieve that registered goal. For example, if a student had a goal of becoming a doctor, the tracking module could recommend and provide activities that focus more keenly on science, math, and other subjects relevant to becoming a doctor.

According to an embodiment of the present invention, the trend tracking module may be able to identify deficiencies in a user's progress towards achieving a goal or aspiration. In a preferred embodiment, the trend tracking module may be configured recognize if a user is not achieving highly in skill sets that are required for a particular goal or aspiration. In the preferred embodiment, the trend tracking module may use this information to identify skill sets in which the user is achieving highly and recommend new goals or ambitions to the user that may be more in line with the user's strengths. Alternatively or in addition to that capability, the trend tracking module may also recommend more in practice in those deficient skill areas to help the user achieve their goal. As an example, imagine a student has goal of becoming a doctor, but struggles with science and math skills, yet achieves highly in writing and social sciences. As a result, the trend tracking module would be able to recognize this pattern and provide more intensive activities in science and math. Alternatively or in addition to that, the trend tracking module could provide recommendations for other goals for the student that more closely matches the students skills set. In this example, the trend tracking module could recommend that the student might be interested be being a lawyer and provide activities that would enhance skills related to that goal. As a result, the student may recognize a previously unknown passion that they might find more rewarding.

According to an embodiment of the present invention, the system and methods herein described may be utilized to identify and analyze not only a child's passions, but a child's aptitude. In one embodiment of the present invention, the system and methods herein described may be utilized to help steer a child towards a subject area that they are not only passionate about, but they possess a certain aptitude for.

According to an embodiment of the present invention, an algorithm may be utilized by the systems and methods herein described to select a question or questions for a user to answer. The process is achieved through the identification of certain points of information or characteristics stored in the system regarding the user. For instance, information or characteristics may include, but are not limited to, a user's language, region, zone, age, IP address, trending passion, or any combination thereof. One of ordinary skill in the art would appreciate that there are numerous pieces of information and characteristics that could be utilized with embodiments of the present invention.

According to an embodiment of the present invention, when a student submits a question, the student's IP address, speaking language, Age, Town, State, Country etc. are noted down. Upon approval of the questions, the question gets published to the same age or closer to the attendee's age student if the language and region matches with the attendee student.

In an exemplary embodiment of the present invention, when a student clicks on “Answer Question” tab and selects subject (e.g. Math, Science, Music, Art etc.), the student is presented a list of questions provided from a data store. The questions may be sorted with all the submitted questions starting from not attempted ones to attempted ones.

In an exemplary embodiment of the present invention, questions in the list are of the same language of the attendee student. This may not always be the case, for instance, where a student is attempting to learn a second language.

In an exemplary embodiment of the present invention, the list may also be sorted by questions appropriate for a user of a particular age as well. Questions targeted towards a user of the same age are at the top of the list, unless the user has been identified as someone who is answering questions above or below their age appropriate level.

In an exemplary embodiment of the present invention, the list may also be sorted by the region of the user, where questions submitted by other users that are geocentrically close to the user are on the top of the list. This is purposefully done so that language ascent of the presenter is closer to the attendee language to understand the question.

In an exemplary embodiment of the present invention, during sorting attempted count of the question also considers the total number of times the answer was correct versus the wrong answers by the attendee student. The questions which are attempted but answered incorrectly are shown before the questions that were answered correctly.

In an exemplary embodiment of the present invention, once the list is sorted based on the above criteria, the list is maintained for that attendee student as long as he or she remains on the same subject. Once a selection criterion is changed, it creates the similar list for that subject. Alternatively, the system can be configured to dynamically update the list after each question is answered or based on other input received from the user.

According to an embodiment of the present invention, once a user attempts to answer a question, the next question in the list is automatically presented based on the sorting method described above. Alternatively, prior to automatically continuing, the user may be prompted to identify if he or she wishes to continue.

Handwriting Grading and Analysis

According to an embodiment of the present invention, additional non-question based activities may be provided by the system and method. Other activities that may be provided to a child include the analysis and grading of the child's handwriting skills. In this embodiment, a child may be presented with the opportunity to provide a handwriting sample to the system. This may be accomplished by having the child use an electronic pointing device (e.g., electronic pen, touch screen device, mouse) or by having the child perform the handwriting on a non-electronic medium (e.g., writing paper) and later transmit the non-electronic medium to the system (e.g., scan and e-mail, facsimile transmission, scan and upload).

According to an embodiment of the present invention the handwriting sample is received by the system. In a preferred embodiment, the sample may be analyzed for correctness, accuracy and improvement. The system may provide a child not only with an overall grade based on the handwriting sample, but may also offer advice for correcting problems identified in the handwriting sample. In this manner, a child not only gets a feeling for how they are progressing, but how also to improve their handwriting in the future.

According to an embodiment of the present invention, the system may be able to provide handwriting analysis in real time. In a preferred embodiment, the child submits the handwriting sample via an electronic pointing device and the system provides instant feedback and corrective tips to guide the child in proper handwriting techniques.

Integration with Standard Methods of Education

According to an embodiment of the present invention, the system and methods herein described may also be utilized in conjunction with more standard forms of education. In this manner, a school or other educational body may offer a syllabus for use with the system and methods herein described. Advantageously, a child may be encouraged to explore various subjects, while being guided by a syllabus presented to the child.

According to this embodiment, a child may be provided the ability to perform homework assignments online and have the school or other educational body track and confirm the completion of these assignments. In a preferred embodiment, the school or other educational body could utilize certain verification methods to make sure a child is performing the work themselves (e.g., checking IP addresses and comparing them with IP addresses known to belong to those of a particular child/patent/guardian). One of ordinary skill in the art would appreciate that there are numerous ways to confirm the identity of a user, and embodiments of the present invention are contemplated for use with any method of confirming a user's identity.

According to an embodiment of the present invention, a user of the system may submit a question to be shared with other users. In a preferred embodiment the question is submitted and it goes through an approval process where an approver reviews the contents of the question and analyzes whether the question is appropriate for the intended group. Upon approval, the question gets published where other kids of the intended age can see the newly submitted question.

According to an embodiment of the present invention, a user can submit questions in any number of formats. In a preferred embodiment, a user may submit a question in the form of text, still images, video, audio or any combination thereof. This allows a questions to become more interactive and engaging for the users.

According to an embodiment of the present invention, an instructor or leader may also use the system to interact with students, users, or other group members. In a preferred embodiment, an instructor or leader can record video to explain a topic and at the end can ask question to the viewers. The instructor or leader may then type one or more questions in a question text box and type one or more correct answers and one or more wrong answers for a viewer or user to select. When this question gets published, all the options get randomized to display it in random order.

According to an embodiment of the present invention, the system can provide a response to a user based upon the answer to a given question. In a preferred embodiment, the response would be primarily based on whether the provided response was correct or incorrect. As an example, if the user provides a correct answer to a science question, the response could be a video or animation showing scientists clapping and cheering the correct response. Alternatively, if a response was incorrect, the response could be a simple message that encourages the user to try again.

Extracurricular Activities

According to an embodiment of the present invention, the systems and methods herein described may be further expanded to offer, track and analyze subjects outside of the academic arena. For instance, a child may be allowed to include various sports activities or other activities (e.g., boy scouts, girl scouts, cub scouts, church affiliations, community organizations) in their use of the system and methods herein described. In this manner, a child's passion and aptitude for civic and other activities not purely related to education may be tracked.

According to an embodiment of the present invention, the system and methods herein in describe may be used by the members of a club or group. In a preferred embodiment, a member of a club or group may log into the system and find their group. The member could then join the group and use the a passcode to authenticate their membership with the group. Once the signup process is completed, of the member can enjoy activities that are provided by that group. As the member completes various activities, those activities are monitored and results may be recorded. Videos may be offered as a part of the activities, showing the group member how to complete the activity. In an optional embodiment, the activities of the member may be monitored by a group leader that can approve the completion of activities. When a group member completes an activity, it registers as being completed in their account.

According to an embodiment of the present invention, the system and method herein described may be used by a group leader to manage and supervise the activities of the group. In a preferred embodiment, the group leader may register through a process that involves creating a new group. Once the group is created, the group leader may create a passcode for the group to limit access to authorized group members. Additionally, the group leader will be able to manage the group in a variety of ways, including, but not limited to, sending out group invitations, creating group activities, and approving completed activities.

According to an embodiment of the present invention, the system and methods herein described may allow for a child to directly participate in scouting activities and have those activities tracked and analyzed in terms of the child's passion and aptitude. This feature may allow for a group of scouts to join and be associated as a single group of scouts. Events and meetings may be tracked through the system and methods herein described. Additionally, activities may be provided through the system and methods herein provided, whereby a scout could earn certain rewards or badges through the completion of certain activities.

Location Based Services

According to embodiment of the present invention, any of the previous systems and methods herein described may be utilized with Location Based Service(LBS) enabled computing devices (e.g., GPS enabled smartphones, GPS enabled laptops) to enhance the access and awareness of members. Any system or method previously described herein may be further enhanced through the use of LBS enabled computing devices. For instance, a LBS enabled computing device may allow a child to confirm their attendance at a scouting activity or sporting event. Rewards or certificates may be awarded based on a child's attendance or performance in a particular event.

### Exemplary Embodiments

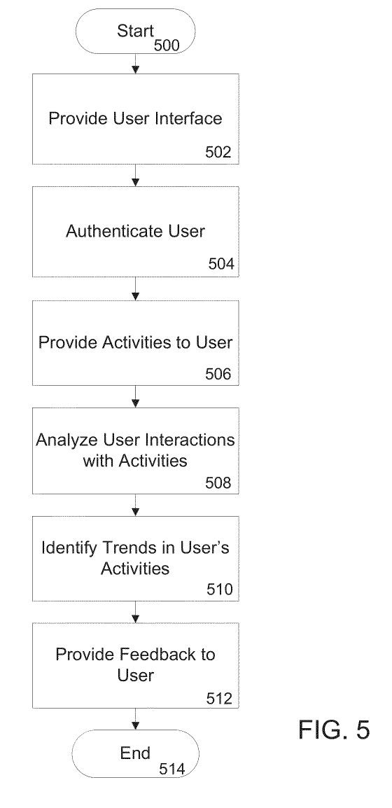

The following is an exemplary embodiment of a method for utilization of the graphic alignment engine, as shown in FIG. 5. At step 500, the process starts with a user activating the system.

At step 502, the system provides a user interface. The interface allows the user to navigate through the system.

At step 504, the system will authenticate the user. First time users will register with the system and returning users will logon to the system with the credentials they entered during resignation.

At step 506, the system will provide the user with activities. These activities may be assigned in many ways including in accordance with a group membership, past activities, or registered interests.

At step 508, the system analyzes the activities of the user. They system can analyze not only what activities the user completes, but also the efficiency and accuracy with which the user completes those activities.

At step 510, the system identifies trends in the user's activities. The systems capabilities may include analyzing what the user's interests are and the user's strengths and weaknesses in completing different activities.

At step 512, the system provides feedback to the user. This feedback may include information about areas of strong performance, areas where the user may improve performance, recommendations on how to improve performance, and recommendations for future activities based on the selection and results of previously completed activities.

At step 514, the process ends.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Furthermore, while multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing trending information using a social networking platform, said system comprising of:
a trend tracking module comprising a processor and a physical memory storing instructions that causes said trend tracking module to:
provide a user interface,
register a user, wherein said user becomes a part of a social network that evaluates activities of said user,
provide one or more activities to said user;
analyze interactions of said user with said one or more activities, wherein said interactions are tracked over time to identify trends, and
provide feedback to said user via said user interface, wherein said feedback is based on identified trends.

2. The a system for providing trending information using a social networking platform of claim 1, further comprising a communications means, wherein said communications means allows said user to utilize said trend tracking module through a computer network.

3. The system of claim 1, further comprising a data store, wherein said data store comprises one or more activities for said user to interact with.

4. The system of claim 1, wherein said system is used for educational purposes.

5. The system of claim 2, wherein the said system is used by school-aged children.

6. The system of claim 1, wherein said one or more activities are educational activities.

7. The system of claim 6, wherein said educational activities are interactive questions.

8. The system of claim 1, wherein in said identified trends are likes and dislikes of said user.

9. The system of claim 1, wherein said feedback identifies one or more attributes of said user, wherein said one or more attributes comprise the aptitude, passions, strengths, and weaknesses of said user.

10. A method for providing trending information using a social networking platform, the method comprising the steps of:
providing a user interface to a user via a trend tracking module;
registering said user, wherein said user becomes a part of a social network that evaluates activities of the user;
providing one or more activities to said user;
analyzing interactions of said user with said one or more activities, wherein said interactions are tracked over time to identify trends;
providing feedback to said user via said user interface, wherein said feedback is based on identified trends.

11. The method of claim 10, further comprising the step of identifying one or more attributes of said user, wherein said one or more attributes comprise the aptitude, passions, strengths, and weaknesses of said user.

12. The method of claim 10, further comprising the step of providing recommendations for future activities, wherein said recommendations are based on said one or more attributes of said user.
